(19) United States
(12) Patent Application Publication
(10) Pub. No.: US 2004/0061387 A1
(43) Pub. Date: Apr. 1, 2004

(54) Magnetically actuated commutator

(75) Inventor: John D. Long, Knoxville, TN (US)

Correspondence Address: PITTS AND BRITTIAN P C, P O BOX 51295, KNOXVILLE, TN, 37950-1295, US

(73) Assignee: Harmonic Drive, Inc., Knoxville, TN

(21) Appl. No.: 10/256,628

(22) Filed: Sep. 27, 2002

(51) Int. Cl. H02K 37/00; H02K 1/00

(52) U.S. Cl. 310/46; 310/233

(57) ABSTRACT

An apparatus for providing commutation for a direct current motor. The commutator has a magnet attached to a pivoting member and means for making and breaking at least one electrical circuit. The commutator magnet interacts with a magnet attached to the rotor. The rotor magnet can be either an independent magnet or one that also provides the motive force for causing the rotor to rotate. When the rotor magnet is adjacent the commutator magnet, the commutator changes state, thereby energizing a stator coil. The commutator has minimal moving parts and avoids the wear and maintenance problems of a conventional brush commutator.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to direct current powered rotating machines. More particularly, this invention pertains to a magnetic commutator actuated by a rotating magnet.

2. Description of the Related Art

Conventional direct current motors have windings on the rotor. These windings create magnetic fields that interact with magnetic fields on the stator, which uses magnets or other windings to create the stator magnetic fields. A common means to achieve rotation of the rotor is to alternate the polarity of the rotor windings with a commutator. The commutator includes two major components. The first major component is a series of opposed bars electrically connected to the windings and that rotates with the rotor. The bars are axially arranged about the axis of rotation of the rotor. The second major component includes pairs of stationary brushes that make contact with the bars on the rotor. An electrical circuit is formed from a brush to a bar, through a rotor winding, and from another bar to another brush. As the rotor rotates, the brushes contact different bars, thereby selectively energizing the rotor windings.

A commutator having brushes creates electrical noise from the constant making and breaking of an inductive circuit. Brush-commutator motors and generators are ordinarily limited in service life and require periodic maintenance because of brush and commutator wear.

Brushless electric motors are known in the art. In general, brushless direct current motors are characteristically relatively expensive owing, at least in part, to their specialized designs and low volume production. Typically, the electrical commutation is achieved with an electronic circuit that determines rotor position by a magnetic sensor, such as a Hall effect device or an inductive coil, or an optical sensor. For example, U.S. Pat. No. 4,115,715, issued to Muller, on Sep. 19, 1978, entitled “Brushless d.c. Motor,” discloses a brushless motor having a permanent magnet rotor and a commutator circuit having an induction coil or a Hall generator. The Hall generator determines the position of the rotor and controls the polarity of the stator windings.

U.S. Pat. No. 4,910,420, issued to Hoover, et al., on Mar. 20, 1990, entitled “Brushless Electric Motor,” discloses a brushless motor having a permanent magnet rotor and stator windings attached to an electronic commutator using a Hall effect device to determine the rotor position.

U.S. Pat. No. 5,783,917, issued to Takekawa on Jul. 21, 1998, entitled “Method and Device for Driving DC Brushless Motor,” discloses using the back electromotive force voltages generated in the drive windings to determine rotor position. The Takekawa disclosure does not require sensors to determine the rotor position.

An alternative machine design is disclosed in U.S. Pat. No. 4,564,778, issued to Yoshida on Jan. 14, 1986, entitled “DC Brushless Electromagnetic Rotary Machine,” which discloses an electrical rotating machine in which the rotor includes a permanent magnet cylinder having one magnetic pole on the outside surface of the cylinder and the other pole on the inside of the cylinder. Direct current applied to the stator windings causes the rotor to rotate. The dc motor disclosed by Yoshida does not require alternating the current direction of any of the windings, and consequently, does not utilize a commutator.

Another alternative machine design is disclosed in U.S. Pat. No. 3,937,993, issued to Noodleman on Feb. 10, 1976, and titled “Commutating Structure for DC Machines.” Noodleman discloses a direct current motor with a permanent magnet rotor and stator windings. Instead of brushes, the stator windings are controlled by roller contacts that continuously and progressively switch the dc source to succeeding stator windings.

### BRIEF SUMMARY OF THE INVENTION

According to one embodiment of the present invention, a brushless commutator for a direct current electric machine is provided. At least one permanent magnet on the rotor actuate at least one magnetic switch that performs the commutation for at least one stator winding. The commutator has a pivoting member, at least one permanent magnet, and means for making and breaking at least one electrical circuit. The commutator magnet interacts with at least one magnet attached to the rotor. The rotor magnet can be either an independent magnet or one that also provides the motive force for causing the rotor to rotate. The commutator has minimal moving parts and avoids the wear and maintenance problems of a conventional brush commutator.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a single-pole single-throw magnetically actuated switch;

FIG. 2 is a plan view of an embodiment of a single-pole double-throw magnetically actuated switch;

FIG. 3 is a plan view of another embodiment of a single-pole double-throw magnetically actuated switch;

FIG. 4 is a perspective view of a single-pole double-throw magnetically actuated switch;

FIG. 5 is a schematic diagram of a two-winding motor with the single-pole double-throw magnetically actuated switch;

FIG. 6 is a wiring diagram of the motor illustrated in FIG. 5;

FIG. 7 is a wiring diagram of a single-winding motor with a double-pole double-throw switch;

FIG. 8 is a schematic diagram of a four-winding motor with two double-pole double-throw magnetically actuated switches;

FIG. 9 is a pictorial diagram of the rotor and switches of the motor illustrated in FIG. 8;

FIG. 10 is a schematic diagram of a three-winding, series connected motor with three single-pole single-throw switches; and

FIG. 11 is a schematic diagram of a three-winding, parallel connected motor with three single-pole single-throw switches.

### DETAILED DESCRIPTION OF THE INVENTION

An apparatus for commutating the stator windings for a direct current machine is disclosed. The commutator does not require brushes with their wear and maintenance requirements. Instead, the present invention has no physical actuating connection between the commutator and the rotor.

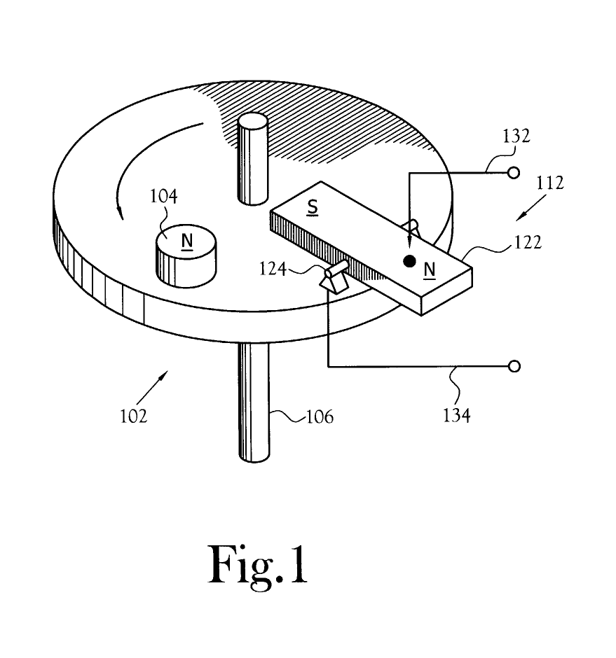

FIG. 1 illustrates a pictorial representation of a rotor 102 having a permanent magnet 104 and a magnetically actuated switch, or commutator, 112. Switch and commutator are used interchangeably; however, the term commutator implies the function of switching current applied to a coil. The illustrated switch 112 is a single-pole, single-throw switch 112 in which, as the north pole N of the rotor magnet 104 passes near the south pole S of the switch actuator 122, one end of the actuator 122 is attracted by the rotor magnet 104 and forces contact with an electrode 132 as the actuator 122 pivots about the pivot 124, thereby closing the switch 112. In another embodiment, the rotor magnet 104 polarity is such that it repels the actuator 122, thereby closing the switch 112. The switch 112 changes state when the rotor magnet 104 is adjacent the switch actuator 122. The means for providing the switching action, namely the contact mating surfaces, are well known in the art. The switch 112 includes switching means and an actuator 122 that causes the switching means to either make or break a circuit.

The switch actuator 122 is a magnet that has a pivot point 124 between the north N and south S poles. In one embodiment, the pivot point 124 includes an axel attached to the actuator 122 and the axel is supported by a pair of bearings, which allow the axel to rotate, causing the actuator 122 to pivot about the axel. The pivot point 124 is conductive and forms the common lead 134 of the switch 112. Other means for having a member pivot about a point are known in the art. The actuator 122, in one embodiment, is a magnet that conducts electricity. One electrical contact 134 is made at the pivot point 124 and the other electrical contact is a make-or-break contact to the electrode 132 that completes the circuit when the north pole N of the actuator 122 is forced against the electrode 132. In another embodiment, the actuator 122 is a pivoting conductor with a magnet attached to it. The magnet moves the conductor in response to the rotor magnet 104. Those skilled in the art will recognize that the switch 112 construction can vary without departing from the scope or spirit of the present invention. FIG. 1 illustrates the rotor magnet 104 as a small cylinder attached to a disk. Those skilled in the art will recognize that the configuration of the rotor magnet 104 can vary without departing from the scope or spirit of the present invention. The aspect of the rotor magnet 104 pertinent to the embodiment illustrated in FIG. 1 is that the rotor magnet 104 attracts one end of the actuator 122 such that contact is made between the electrodes 132 and 134. In another embodiment, the rotor magnet 104 repels the other end of the actuator 122 such that contact is made between the electrodes 132 and 134.

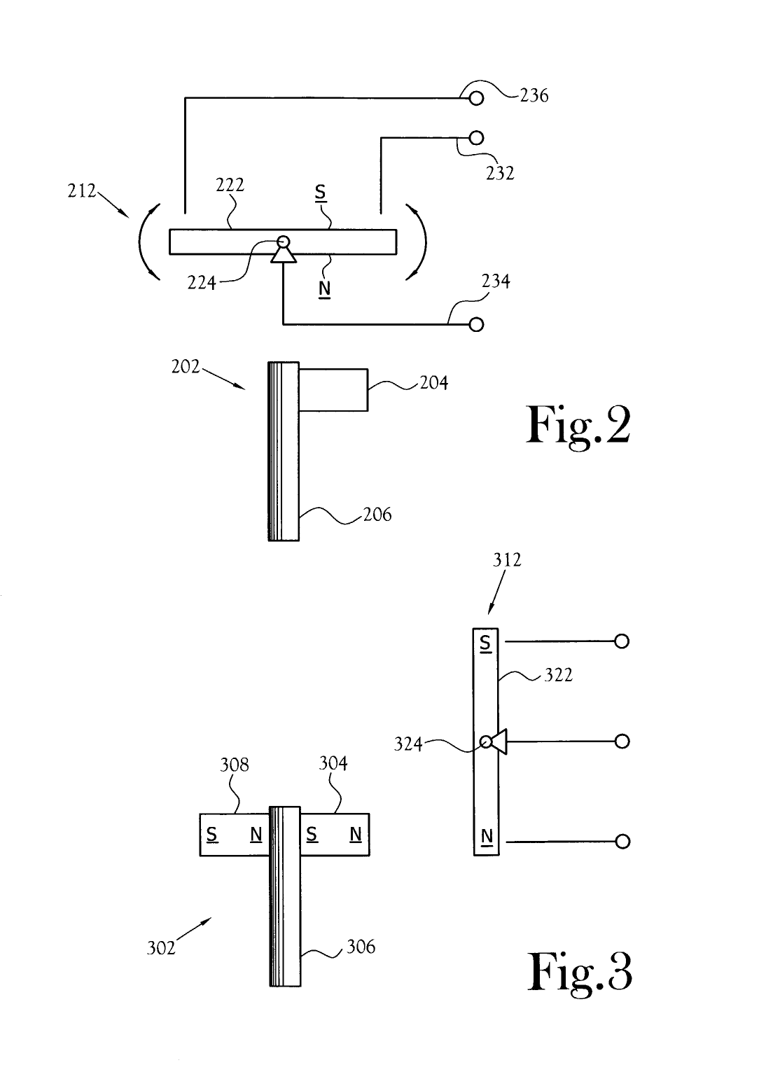

FIG. 2 illustrates a single-pole double-throw switch, or commutator, 212 with its pivot point 224 positioned inline with the axis of the rotor 202. As the rotor 202 rotates, the rotor magnet 204 alternatingly interacts with each end of the switch, or commutator, 212. The switch 212 is a normally open, momentary contact, single-pole, double-pole switch because the common electrode 234 momentarily makes contact with one of two other electrodes 232 and 236. Those skilled in the art will recognize that the orientation of the magnetic poles of the rotor magnet 204 can vary without departing from the spirit and scope of the present invention. The poles of the rotor magnet 204 need to be arranged such that the desired movement of the actuator 222 is achieved. The illustrated embodiment shows a one-piece magnet forming the actuator 222, with the poles oriented top and bottom, relatively. In another embodiment, the actuator 222 is a member to which one or more magnets are attached and the rotor magnet 204 interacts with the attached magnets.

FIG. 3 illustrates another embodiment in which the switch, or commutator, 312 is oriented parallel to the axis of the rotor 302. Magnetic interaction is well known in the art and those skilled in the art will recognize that the orientation of the switch 312 with respect to the rotor 302 and the rotor magnets 308, 308 can vary without departing from the spirit and scope of the present invention.

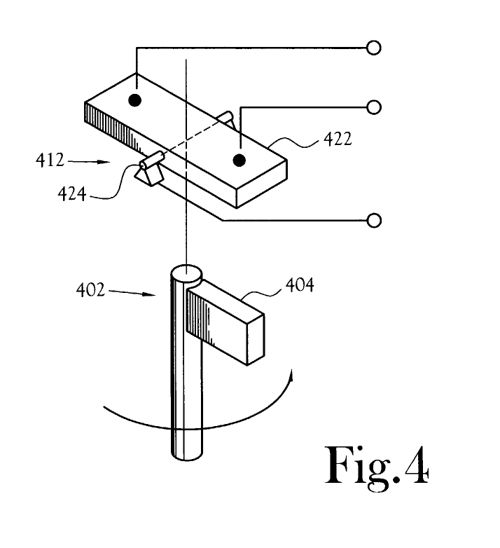

FIG. 4 is a perspective view of the embodiment illustrated in FIG. 2. The rotor 402 rotates such that the rotor magnet 404 interacts with the magnetic poles of the switch actuator 422, causing the switch, or commutator, 412 to operate. As the rotor magnet 404 moves adjacent one of the distal ends of the actuator member 422, the end of the actuator member 422 is either repelled or attracted, depending upon the orientation of the magnetic poles of the actuator member 422 and the rotor magnet 404.

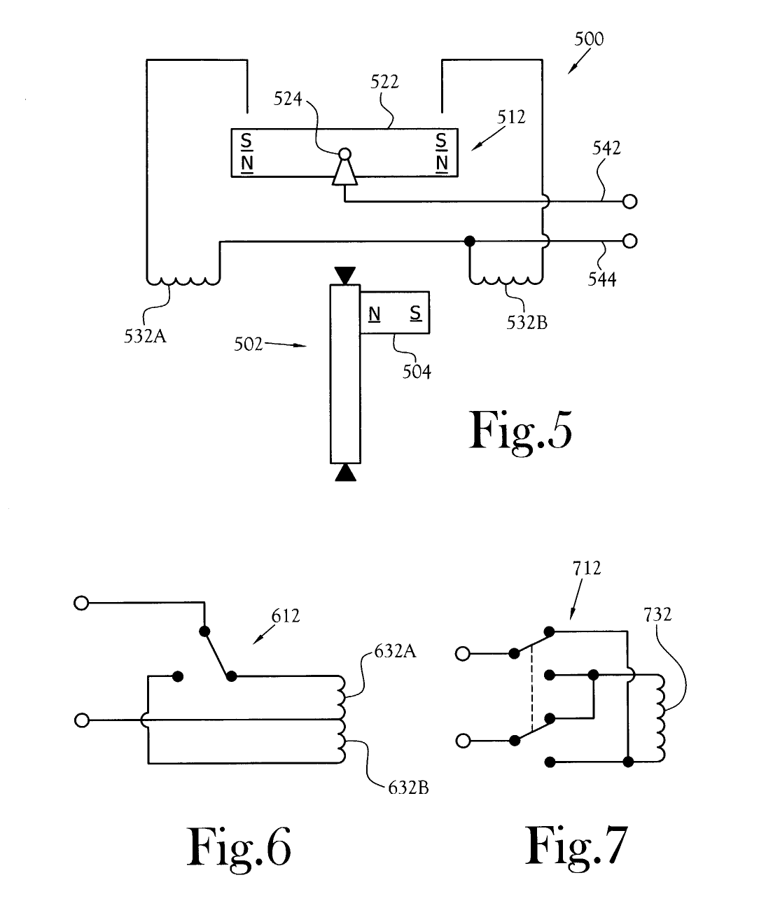

FIG. 5 is a schematic/pictorial diagram of a direct current motor 500. The rotor 502 includes a rotor magnet 504 that interacts with a center-tapped stator coil 532. The commutator 512 operates by magnetic interaction between the actuator 522 and the rotor magnet 504. Those skilled in the art will recognize that the rotor magnet 504 can be a permanent magnet that is acted upon by the stator coils 532 or it can be a permanent magnet separate from the rotor magnets. The poles of the rotor magnet 504 are illustrated to show one embodiment. Those skilled in the art will recognize that the poles of the rotor magnet 504 and the poles of the actuator 522 are to be arranged so as to produce the desired magnetic interaction. Direct current voltage is applied to conductors 542 and 544, one of which 542 is the common lead for the commutator 512 and the other 544 is connected to the center tap of the coil 532.

The stator coils 532A, 532B are the means for generating the electromagnetic fields that cause the rotor 502 to rotate. Various arrangements of rotors 502 and stator coils 532A, 532B are known for causing the rotor 502 to rotate. These arrangements depend upon the stator coils 532A, 532B being energized and generating an electromagnetic field when the rotor 502 is in such a position as to apply torque to the rotor 502. In one embodiment, the axis of the stator electromagnetic field is perpendicular to the axis of rotation of the rotor 502. The rotor magnet 504, or other driving magnet, is positioned such that the stator electromagnetic field causes the rotor magnet 504, or other driving magnet, to line up with the axis of the stator electromagnetic field. The actuator 522 is the means for energizing the stator coils 532A, 532B when the rotor 502 is in the proper position. The rotor magnet 504 is positioned relative to the actuator 522 so as to energize the appropriate stator coil 532A or 532B to cause the rotor 502 to rotate. In addition to commutating the stator coils 532A, 532B, an actuator 522 can be used as a switch sensing rotor 502 position or rotor 502 speed.

FIG. 5 shows the actuator 522 in the center position for illustrative purposes. Normally, the actuator 522 is in one of the two extreme positions based on the position of the rotor magnet 504. With one winding 532A or 532B energized by the commutator 512, the rotor magnet 504 attempts to orient itself to the magnetic field created by the energized winding 532A or 532B, thereby causing the rotor 502 to rotate about its axis. As the rotor 502 rotates, the rotor magnet 504 changes its position and causes the commutator 512 to operate, which causes the magnetic field generated by the stator coils 532A, 532B to alternatingly reverse directions, thereby forcing the rotor magnet 504 to continue rotating about the shaft of the rotor 502.

Those skilled in the art will recognize that the stator and rotor of the motor 500 can be constructed in many ways without departing from the spirit and scope of the present invention. For example, in one embodiment, the stator windings 532 are wound around a core that has an inside surface curved to minimize the air gap between the core and the rotor magnets. The rotor 502 can consist of known arrangements of rotor magnets 504 with the commutator interacting with either the rotor magnet 504 or an additional magnet attached to the rotor 502.

FIG. 6 illustrates a wiring diagram for one embodiment of a center-tapped coil 632. A single-pole double-throw switch, or commutator, 612 alternately energizes one half of the coil 632A or 632B, thereby causing the generated magnetic field to alternatingly reverse. In another embodiment, the stator coils 632A, 632B are two independent coils with coincident electromagnetic fields that have opposing polarities when energized. The commutator 612 is actuated by a rotor magnet 504 when the rotor 502 is in such a position for the energized coil 632A or 632B to apply torque to the rotor 502.

FIG. 7 illustrates a wiring diagram of another embodiment of a motor 500. A double-pole double-throw switch, or commutator, 712 alternately energizes the stator coil 732 first with one polarity and then with an opposite polarity. Each time the switch 712 toggles position, the magnetic field generated by the stator coil 732 reverses direction, thereby achieving the same result as the embodiment illustrated in FIG. 6.

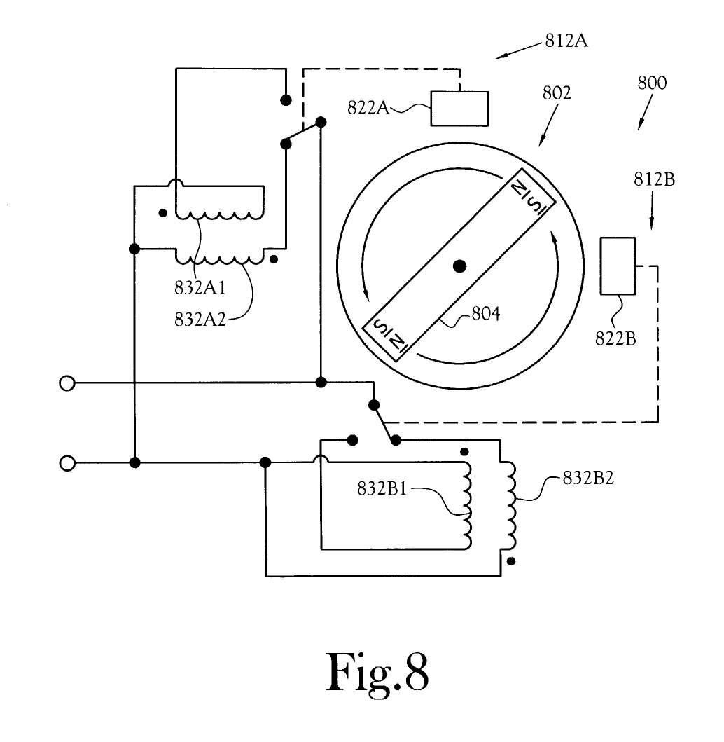

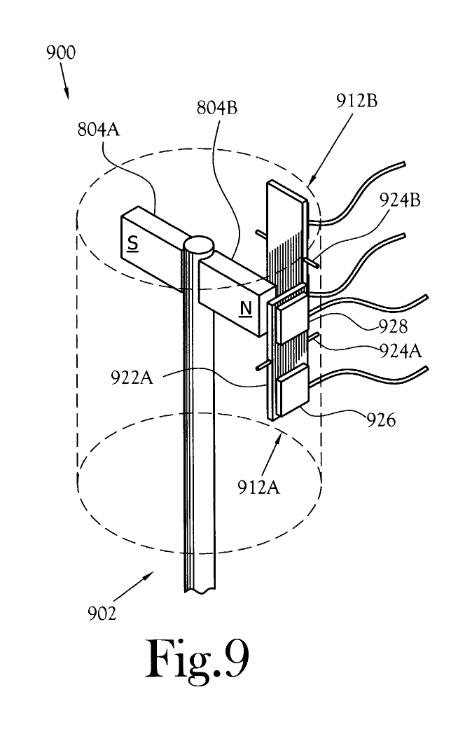

FIG. 8 is a schematic of a four-winding direct current motor 800. Two single-pole double-throw commutators 812A and 812B alternately energize stator windings 832A1, 832A2, 932B1, 832B2, thereby creating magnetic fields that attract the rotor magnet 804 and cause the rotor 802 to rotate. In the illustrated embodiment, the rotor magnet 804 has two distal ends that extend from the rotor axis, and each end has a north-south pole oriented tangent to the rotor 802. Those skilled in the art will recognize that other configurations of rotor magnets can be used without departing from the scope and spirit of the present invention. The orientation of the actuators 822 must be such that the actuators 622 are operated by the rotor magnet 804 at the point where the desired torque can be achieved. As the rotor magnet 804 rotates and approaches the actuator 822, the actuator changes position and a different coil 832 is energized. The energized coil 832 causes the rotor 802 to rotate as the rotor magnet 804 tries to align itself with the magnetic field generated by the energized coil 832. One set of stator coils 832A1, 832A2 are orthogonal to the other set of stator coils 832B1, 832B2, that is, the electromagnetic field of one set of coils 832A1, 832A2 is at a right angle to the coincident electromagnetic field of the other set of coils 832B1, 832B2. The axis of each of the electromagnetic fields of the coils 832A1, 832A2, 932B1, 832B2 are aligned perpendicular to the axis of rotation of the rotor 802. In another embodiment, two center-tapped coils replace the two pairs of coils 832A1, 832A2, and 932B1, 832B2.

FIG. 9 illustrates a partial view of one embodiment of a four-winding direct current motor 900 showing the arrangement of the rotor magnets 804A and 804B to the commutators 922A and 922B. The commutators 912A and 912B are radially 90° apart and have single-pole double-throw switches. As the rotor magnet 804 passes by the commutator 912A or 912B, the commutator 912A or 912B operates and the switch changes position, thereby energizing the appropriate winding as illustrated in FIG. 9. In the illustrated embodiment, the commutators 912 include a member 922A with a pivot point 924A between a pair of magnets 926 and 928 at the distal ends away from the pivot 924A. In another embodiment, the commutator 912 has only a single magnet located at one or the other end of the actuator member 922.

The rotor magnet 804 interacts with the commutator magnets 926, 928 such that the north pole of the rotor magnet 804 repels the adjacent north pole face of the commutator magnet 926, thereby actuating, or toggling, the switch and completing one electrical circuit. As the rotor magnet 804 revolves and the south pole comes adjacent the commutator magnet 926, the south pole of the rotor magnet 804 attracts the north pole face of the commutator magnet 926, thereby toggling the switch in the other direction and completing the other electrical circuit.

Referring to FIGS. 8 and 9, the actuators 822A, 822B, 922A, 922B are positioned less than 90° from the magnetic axis of the coil 832 operated by that commutator 812, 912. The torque developed by the rotor 802 varies with the angular difference between the magnetic axis of the coil 832 and the actuator 822. The actuators, or commutators, 812A and 812B, in one embodiment, are mounted on a ring (not illustrated) that rotates about the axis of rotation of the rotor 802. The ring permits the angle between the magnetic axis of the coil 832 and the actuator 812 to be changed, thereby changing the torque developed by the motor 800. In one embodiment, a null is reached when the actuator 812 is 90° to the associated magnetic field of the coil 832. As the ring is rotated and moves the actuator 812 closer to the associated magnetic field of the coil 832, the available torque increases, which has the effect of increasing the rotor rotational speed if the load is constant. If the ring 814 is rotated in the opposite direction away from the null point, the rotor 802 rotates in the opposite direction. In another embodiment, the rotor magnet 804 is independent of the driving magnets on the rotor, in which case the null point and maximum torque point are related to the location of the rotor magnet 804 relative to the driving magnets.

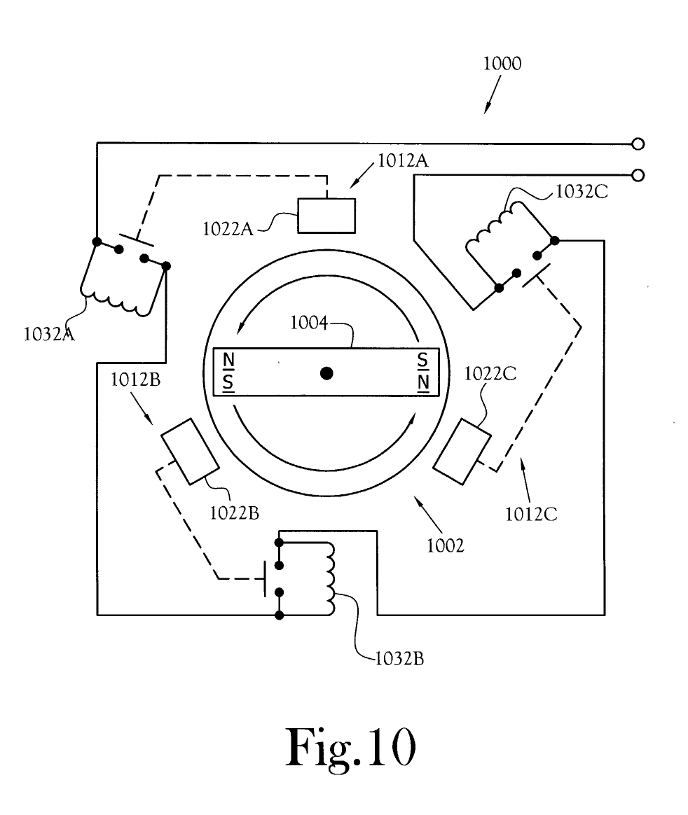

FIG. 10 is a schematic/pictorial diagram of a direct current motor 1000 having three series connected coils 1032. The commutators 1012 in this embodiment are single-pole single-throw switches. Each coil 1032 has an associated commutator 1012 that bypasses the coil 1032, thereby eliminating its magnetic field and allowing the rotor 1002 to be acted upon by the other two coils 1032. The actuators 1022 are positioned such that when the rotor magnet 1004 interacts with the actuator 1022, the rotor magnet 1004 is attracted/repelled by the magnetic fields generated by the energized coils 1032, thereby imparting rotary motion to the rotor 1002. In another embodiment, the rotor magnet 1004 is distinct from the driving magnets relied upon to impart rotary motion to the rotor 1002, and the coils 1032 interact with the driving magnets to cause the rotation of the rotor.

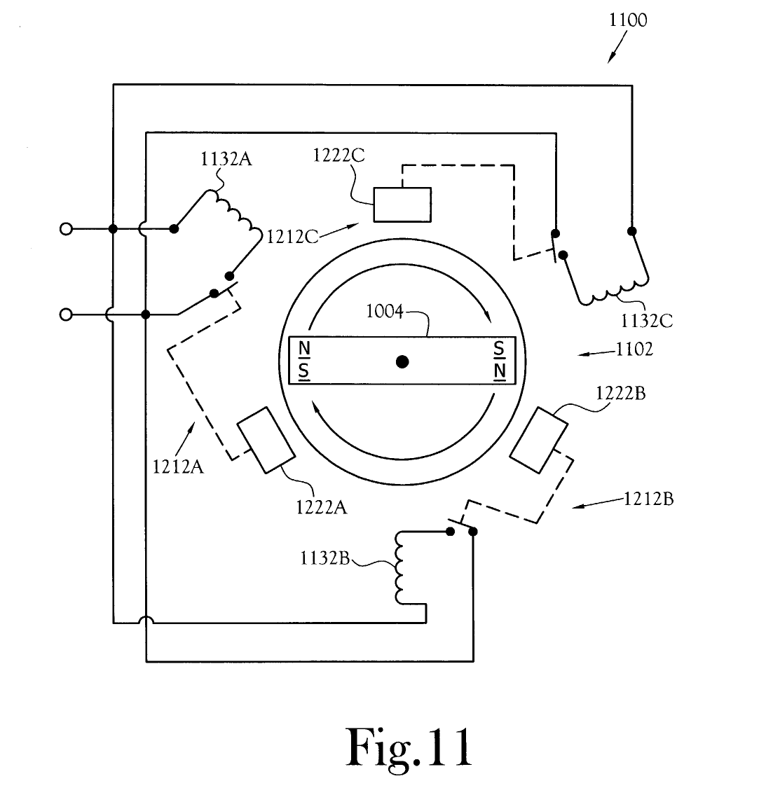

FIG. 11 is a schematic/pictorial diagram of a direct current motor 1100 having three parallel connected coils 1132. The commutators 1112 in this embodiment are single-pole single-throw switches. Each coil 1132 has an associated commutator 1112 that energizes the associated coil 1132A, 1132B, 1132C, thereby generating a magnetic field that interacts with the rotor 1102. The actuators 1122 are positioned such that when the rotor magnet 1104 interacts with the actuator 1122, the rotor magnet 1104 is attracted/repelled by the magnetic fields generated by the energized coils 1132, thereby imparting rotary motion to the rotor 1102. In another embodiment, the rotor magnet 1104 is distinct from the driving magnets relied upon to impart rotary motion to the rotor 1102, and the coils 1132 interact with the driving magnets to cause the rotation of the rotor.

From the foregoing description, it will be recognized by those skilled in the art that a magnetically actuated commutator has been provided. The commutator has a magnet attached to a pivoting member and means for making and breaking at least one electrical circuit. The commutator magnet interacts with a magnet attached to the rotor. The rotor magnet can be either an independent magnet or one that also provides the motive force for causing the rotor to rotate. The commutator has minimal moving parts and avoids the wear and maintenance problems of a conventional brush commutator.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A motor powered from a direct current source, said motor comprising:
a first stator winding generating a first electromagnetic field;
a rotor shaft rotatable within said first electromagnetic field;
a rotor magnet attached to said rotor shaft such that said rotor magnet follows a circular path as said rotor shaft rotates;
a pivoting member having a pivot point held in a spatial relationship with said first stator winding;
a first pivot magnet attached to said pivoting member; and
a first means for switching actuated by said pivoting member, said means for switching energizing said first stator winding when said rotor shaft is at a specified position.

2. The motor of claim 1 wherein said means for switching includes a first switch selectively movable between a first position and a second position, said first switch operated by said pivoting member, said first switch being in said first position when said first pivot magnet is adjacent said rotor magnet, said first switch electrically connected to said first stator winding and to the direct current source.

3. The motor of claim 2 wherein said switch is connected electrically in series with said first stator winding and the direct current source.

4. The motor of claim 1 wherein said first means for switching is selectively positionable about a circumference of an axis of rotation of said rotor shaft.

5. The motor of claim 1 further including
a second stator winding generating a second electromagnetic field, said second electromagnetic field coincident with said first electromagnetic field, said second electromagnetic field having an opposite polarity to said first electromagnetic field;
a second pivot magnet attached to said pivoting member; and
a second means for switching actuated by said pivoting member, said second means for switching energizes said second stator winding when said rotor shaft is at a second specified position.

6. The motor of claim 5 wherein said means for switching includes a second switch selectively movable between a first position and a second position, said second switch operated by said pivoting member, said second switch being in said first position when said second pivot magnet is adjacent said rotor magnet, said second switch electrically connected to said second stator winding and to the direct current source.

7. The motor of claim 6 wherein said second switch is connected electrically in series with said second stator winding and the direct current source.

8. The motor of claim 1 further including
a second stator winding generating a second electromagnetic field, said second electromagnetic field at an angle to said first electromagnetic field;
a second pivoting member having a second pivot point held in a spatial relationship with said second stator winding;
a second pivot magnet attached to said second pivoting member; and
a second means for switching actuated by said second pivoting member, said second means for switching energizes said second stator winding when said rotor shaft is at a second specified position.

9. The motor of claim 8 wherein said second electromagnetic field is orthogonal to said first electromagnetic field.

10. The motor of claim 8 wherein said means for switching includes a second switch selectively movable between a first position and a second position, said second switch operated by said second pivoting member, said second switch being in said first position when said second pivot magnet is adjacent said rotor magnet, said second switch electrically connected to said second stator winding and to the direct current source.

11. The motor of claim 10 wherein said second switch is connected electrically in series with said second stator winding and the direct current source.

12. A commutator sensitive to a magnetic field of a rotor magnet, said commutator comprising:
a pivot point;
a member being free to pivot about said pivot point, said member having a first distal end;
a first magnet attached to said member at said first distal end;
a second magnet attached to a rotor;
a first pair of switch contacts acted upon by said member, said first pair of switch contacts being closed only when said first magnet interacts with said second magnet.

13. The commutator of claim 12 further including a second pair of switch contacts acted upon by said member, said second pair of switch contacts being closed when said first pair of switch contacts is open.

14. The commutator of claim 12 further including a third magnet attached to said member at a second distal end opposite said first distal end; a fourth magnet attached to said rotor; and a second pair of switch contacts acted upon by said member, said second pair of switch contacts being closed only when said third magnet interacts with said fourth magnet.

15. A motor powered from a direct current source, said motor comprising:
a means for generating a first electromagnetic field; and
a means for interacting with a magnet attached to a rotor, said means for interacting operating a first means for energizing said first electromagnetic field.

16. The motor of claim 15 further including
a means for generating a second electromagnetic field coincident with said first electromagnetic field, said second electromagnetic field having an opposite polarity to said first electromagnetic field; and
said means for interacting operating a second means for energizing said second electromagnetic field.

17. The motor of claim 15 further including
a means for generating a third electromagnetic field, said third electromagnetic field orthogonal to said first electromagnetic field; and
a means for interacting with a magnet attached to a rotor, said means for interacting operating a third means for energizing said first electromagnetic field.
a means for generating a fourth electromagnetic field coincident with said third electromagnetic field, said fourth electromagnetic field having an opposite polarity to said third electromagnetic field; and
said means for interacting operating a third means for energizing said third electromagnetic field.
